(19) United States
(12) Patent Application Publication
(10) Pub. No.: US 2003/0232617 A1
(43) Pub. Date: Dec. 18, 2003

(54) Radio terminal procedure method and radio terminal system

(76) Inventors: Takashi Ishihara, Zama-shi (JP); Yasuhito Kato, Tokyo (JP); Tetsuya Kamijo, Tokyo (JP); Hiroyuki Terao, Saitama-shi (JP); Yoshimitsu Sano, Yokohama-shi (JP)

Correspondence Address: EDWARDS & ANGELL, LLP, P.O. BOX 9169, BOSTON, MA, 02209, US

(21) Appl. No.: 10/333,393

(22) PCT Filed: Jul. 26, 2001
(86) PCT No.: PCT/JP01/06430

(30) Foreign Application Priority Data
Jul. 27, 2000 (JP) 2000-227661

(51) Int. Cl. H04M 1/66; H04M 1/68; H04M 3/16; H04M 3/00

(52) U.S. Cl. 455/411; 455/419

(57) ABSTRACT

A user makes a call to a center station (30) using a radio terminal (1) requesting communication. An authentication station (20) authenticates the call by checking a calling number that is attached to the call against the calling number that corresponds to this radio terminal and is managed at the authentication station. The authentication station then connects the call between the radio terminal and the center station so that they communicate with each other via a radio network (10). The user uses the radio terminal to fill in predetermined information on an input form sent from the center station. The input form on which the entries have been filled in is sent from the radio terminal to the center station, and contract procedures, contract annulment, or model change procedures with a communication provider are performed. If required, the radio terminal registers the calling number sent from the center station.

### TECHNICAL FIELD

The present invention relates to a radio terminal such as a mobile telephone or PHS (Personal Handy-phone System) that belongs to a user, and, in particular, to a radio terminal contract procedure method and radio terminal system for carrying out the contract procedures with communication providers who collect the considerations that accrue as a result of the use of the radio network of the radio terminal.

### BACKGROUND ART

Conventionally, the contract procedures carried out with a communication provider that are necessary when a user purchases a new mobile telephone or PHS terminal (referred to below as a “radio terminal”) can only be performed at a sales outlet or designated customer service counter or the like that is specified by the communication provider. Namely, the contract procedures relating to the aforementioned radio terminal cannot be performed unless the user actually appears in person at the service counter. The reason for this is that in these procedures it is necessary that predetermined information be recorded in the radio terminal. In order to improve this situation, it has been necessary for the predetermined information to be recorded at the point when the radio terminal was shipped.

However, in the conventional technology, in order for the communication provider to be able to accept a large number of new radio terminal subscribers, the communication provider has had to provide a large number of designated customer service counters (i.e. sales outlets and the like). From the viewpoint of the user, if there is no designated service counter at a location near the user when the user needs to perform the contract procedures relating to a new subscription, the user needs to make a special journey to appear in person at a service counter a considerable distance away, which may not be convenient for the user. Moreover, the contract procedures cannot be carried out outside of normal business hours even if the user does appear in person at a designated service counter. In addition, if the predetermined information is recorded at the point when the radio terminal is shipped, because a calling number (i.e. the telephone number of the radio terminal), of which there are limited resources, is contained in this predetermined information, if, for example, after the user has purchased the radio terminal, that user does not perform the new subscription contract procedures for that radio terminal, the calling number recorded for that radio terminal becomes a missing number. From the viewpoint of the communication provider, this creates a drawback in that the calling numbers, which are the limited resources, cannot be effectively used.

### DISCLOSURE OF INVENTION

The present invention was conceived in view of the above problems and it is an object thereof to provide a radio terminal contract procedure method and radio terminal system that enable contract procedures to be carried out and also enable contract annulment and model change procedures to be carried out with a communication provider using the radio terminal purchased by a user.

The first aspect of the present invention is a radio terminal procedure method for a user of a radio terminal to perform a procedure for a contract for a new subscription with a communication provider, wherein the contract procedure comprises a temporary contract procedure and a formal contract transition procedure that uses information to make a transition to a formal contract that is made known by the communication provider after the temporary contract procedure, wherein the temporary contract procedure comprises: a call process in which the radio terminal makes a call requesting communication with a center device belonging to the communication provider based on a predetermined operation performed using the radio terminal; and a temporary contract process in which mutual communication between the radio terminal and the center device via a predetermined radio network is made possible by the call process, and temporary contract information is sent from the radio terminal to the center device and the individual information sent from the center device is registered, and wherein the formal contract transition procedure comprises: a call process in which the radio terminal makes a call requesting communication with the center device based on a predetermined operation performed using the radio terminal; and a formal contract transition process in which mutual communication between the radio terminal and the center device via the predetermined radio network is made possible by the call process, and formal contract transition information that includes individual information is sent from the radio terminal to the center device and a transition is made from the temporary contract to a formal contract.

The second aspect of the present invention is a radio terminal procedure method for a user of a radio terminal to perform a contract annulment procedure with a communication provider, wherein the contract annulment procedure comprises: a call process in which the radio terminal makes a call requesting communication with a center device belonging to the communication provider based on a predetermined operation performed using the radio terminal; and a contract annulment process in which mutual communication between the radio terminal and the center device via a predetermined radio network is made possible by the call process, and contract annulment information is sent from the radio terminal to the center device and the contract is annulled.

The third aspect of the present invention is a radio terminal procedure method for a user of a radio terminal to perform a model change procedure with a communication provider, wherein the model change procedure comprises: an old terminal operation stopping procedure for stopping use of a radio terminal that has been used prior to the change of model; and a new terminal operation starting procedure for starting use of the changed model of radio terminal after the old terminal operation stopping procedure has been performed, wherein the old terminal operation stopping procedure comprises: a call process in which the radio terminal before the model change makes a call requesting communication with a center device belonging to the communication provider based on a predetermined operation performed using the radio terminal; and an old terminal operation stopping process in which mutual communication between the radio terminal before the model change and the center device via a predetermined radio network is made possible by the call process, and old terminal operation stopping information is sent from the radio terminal before the model change to the center device and use of the radio terminal before the model change is stopped, and wherein the new terminal operation starting procedure comprises: a call process in which the changed model of radio terminal makes a call requesting communication with the center device based on a predetermined operation performed using the radio terminal; and a new terminal operation starting process in which mutual communication between the changed model of radio terminal and the center device via the predetermined radio network is made possible by the call process, and new terminal operation starting information is sent from the changed model of radio terminal to the center device and individual information of the radio terminal before the model change sent from the center device is registered in the changed model of radio terminal.

The fourth aspect of the present invention is a radio terminal procedure method for a user of a radio terminal to perform a procedure for a contract for a new subscription with a communication provider, wherein the contract procedure comprises a temporary contract procedure and a formal contract transition procedure that uses information for making a transition to a formal contract that is made known by the communication provider after the temporary contract procedure, wherein the temporary contract procedure comprises: a call process in which the radio terminal makes a call requesting communication with a center device belonging to the communication provider based on a predetermined operation performed using the radio terminal and makes known predetermined individual information of the radio terminal by attaching the predetermined individual information to the call; an authentication process in which authentication is made by the individual information made known in the call process being checked against individual information of the radio terminal managed by an authentication device and in which the call from the radio terminal is then connected to the center device via a predetermined radio network; and a temporary contract process in which mutual communication between the radio terminal and the center device is made possible by the connection of the call, and temporary contract information is sent from the radio terminal to the center device and individual information newly sent from the center device is registered based on the temporary contract information, and wherein the formal contract transition procedure comprises: a call process in which the radio terminal makes a call requesting communication with the center device based on a predetermined operation performed using the radio terminal and makes known the individual information newly registered in the temporary contract process by attaching this newly registered individual information to the call; an authentication process in which authentication is made by the individual information made known in the call process being checked against individual information of the radio terminal managed by the authentication device and in which the call from the radio terminal is then connected to the center device via the predetermined radio network; and a formal contract transition process in which mutual communication between the radio terminal and the center device is made possible by the connection of the call, and formal contract transition information is sent from the radio terminal to the center device and the temporary contract is changed to a formal contract.

The fifth aspect of the present invention is a radio terminal procedure method for a user of a radio terminal to perform a contract annulment procedure with a communication provider, wherein the contract annulment procedure comprises: a call process in which the radio terminal makes a call requesting communication with a center device belonging to the communication provider based on a predetermined operation performed using the radio terminal and makes known predetermined individual information of the radio terminal by attaching the predetermined individual information to the call; an authentication process in which authentication is made by the individual information made known in the call process being checked against individual information of the radio terminal managed by an authentication device and in which the call from the radio terminal is then connected to the center device via a predetermined radio network; and a contract annulment process in which mutual communication between the radio terminal and the center device is made possible by the connection of the call, and contract annulment information is sent from the radio terminal to the center device and the contract is annulled.

The sixth aspect of the present invention is a radio terminal procedure method for a user of a radio terminal to perform a model change procedure with a communication provider, wherein the model change procedure comprises: an old terminal operation stopping procedure for stopping use of a radio terminal that has been in use prior to the model change; and a new terminal operation starting procedure for starting use of the changed model of radio terminal after the old terminal operation stopping procedure has been performed, wherein the old terminal operation stopping procedure comprises: a call process in which the radio terminal before the model change makes a call requesting communication with a center device belonging to the communication provider based on a predetermined operation performed using the radio terminal and makes known predetermined individual information of the radio terminal by attaching the predetermined individual information to the call; an authentication process in which authentication is made by the individual information made known in the call process being checked against individual information of the radio terminal managed by an authentication device and in which the call from the radio terminal is then connected to the center device via a predetermined radio network; and an old terminal operation stopping process in which mutual communication between the radio terminal and the center device is made possible by the connection of the call, and old terminal operation stopping information is sent from the radio terminal to the center device and use of the radio terminal prior to the model change is stopped, and wherein the new terminal operation starting procedure comprises: a call process in which a call requesting communication with the center device is made based on a predetermined operation performed using the radio terminal after the model is changed, and predetermined individual information of the radio terminal is made known by being attached to the call; an authentication process in which authentication is made by the individual information made known in the call process being checked against individual information of the radio terminal managed by the authentication device and in which the call from the radio terminal is then connected to the center device via the predetermined radio network; and a new terminal operation starting process in which mutual communication between the radio terminal and the center device is made possible by the connection of the call, and model change information is sent from the radio terminal to the center device and individual information of the radio terminal before the model change sent from the center device is registered in the changed model of radio terminal.

The seventh aspect of the present invention is the radio terminal procedure method according to any of the first through sixth aspects, wherein, in the call process, the call requesting communication is made to the center device by a sign up command activated based on a predetermined operation performed using the radio terminal.

The eighth aspect of the present invention is the radio terminal procedure method according to any of the fourth through sixth aspects, wherein the individual information of the radio terminal includes a calling number and information managed by the authentication device or the center device, and the calling number is a calling number sent by the center device and registered or a dummy calling number registered in advance in the radio terminal.

The ninth aspect of the present invention is the radio terminal procedure method according to the first or fourth aspects, wherein the formal contract transition information includes an open communication key that is necessary for performing the formal contract transition procedure and is made known by the communication provider by means other than communication using a radio telephone.

The tenth aspect of the present invention is the radio terminal procedure method according to the second or fifth aspects, wherein the contract annulment information includes a contract annulment key that is necessary for performing the contract annulment procedure and is made known by the communication provider by means other than communication using the radio terminal.

The eleventh aspect of the present invention is the radio terminal procedure method according to the third or sixth aspects, wherein the old terminal operation stopping information includes a model change key that is necessary for performing the model change procedure and is made known by the communication provider by means other than communication using the radio terminal.

The twelfth aspect of the present invention is the radio terminal procedure method according to any of the first through sixth aspects, wherein predetermined information sent from the radio terminal to the center device fills in a predetermined input form sent from the center device and is entered by the user using the radio terminal.

The thirteenth aspect of the present invention is a center device used in a radio terminal procedure method for a user of a radio terminal to perform a procedure for a contract for a new subscription with a communication provider, comprising: communication section for communicating mutually with a radio terminal to which it is connected via a predetermined radio network; contract information requesting section that uses the communication section to receive requests for a temporary contract procedure or a formal contract transition procedure sent from the radio terminal and to request the radio terminal for predetermined contract information in accordance with the received requests; temporary contract section that receives predetermined contract information sent from the radio terminal using the contract information requesting section and when the received contract information is temporary contract information, based on the temporary contract information, acquires individual information from a predetermined database, records the temporary contract information in the database, and sends individual information to be recorded in the radio terminal; formal contract transition section that receives predetermined contract information sent from the radio terminal using the contract information requesting section and when the received contract information is formal contract transition information, checks the formal contract transition information against information registered in a predetermined database; and open communication key setting section that, after the sending of the individual information to the radio terminal by the temporary contract section, sets an open communication key for use in a formal contract transition procedure that corresponds to the individual information and records the open communication key in a predetermined database.

The fourteenth aspect of the present invention is a center device used in a radio terminal procedure method for a user of a radio terminal to perform a contract annulment procedure with a communication provider, comprising: contract annulment key setting section that, based on an application from the user of the radio terminal to annul the contract, sets in advance a contract annulment key for use in a contract annulment procedure that corresponds to the individual information of the radio terminal and records the contract annulment key in a predetermined database; communication section for communicating mutually with the radio terminal to which it is connected via a predetermined radio network; contract information requesting section that uses the communication section to receive requests for a contract annulment procedure sent from the radio terminal and to request the radio terminal for contract annulment information in accordance with the received requests; contract annulment section that receives the contract annulment information sent from the radio terminal using the contract information requesting section and checks the received contract annulment information against information recorded in a predetermined database.

The fifteenth aspect of the present invention is a center device used in a radio terminal procedure method for a user of a radio terminal to perform a model change procedure with a communication provider, comprising: model change key setting section that, based on an application from the user of the radio terminal to change the model of radio terminal, sets in advance a model change key for use in a model change procedure that corresponds to the individual information of the radio terminal and records the model change key in a predetermined database; communication section for communicating mutually with the radio terminal to which it is connected via a predetermined radio network; model change information requesting section that uses the communication section to receive requests for an old terminal operation stopping procedure or a new terminal operation starting procedure sent from the radio terminal and to request the radio terminal for predetermined model change information in accordance with the received requests; old terminal operation stopping section that receives the predetermined model change information sent from the radio terminal using the model change information requesting section and when the received model change information is old terminal operation stopping information, checks this old terminal operation stopping information against information registered in a predetermined database; and new terminal operation starting section that receives the predetermined model change information sent from the radio terminal using the model change information requesting section and when the received model change information is new terminal operation starting information, based on this new terminal operation starting information, registers the new terminal operation starting information in a predetermined database and sends individual information to be recorded in the radio terminal.

The sixteenth aspect of the present invention is a radio terminal system that a user of a radio terminal uses to perform new subscription contract procedures, contract annulment procedures, and model change procedures with a communication provider, comprising: a radio terminal used by the user; and a center device with which the radio terminal communicates via a predetermined radio network, wherein call section for requesting communication with the center device belonging to the communication provider through a predetermined operation performed on the radio terminal is provided in the radio terminal, and communication section for communicating with the radio terminal to which the center device has been connected via the predetermined radio network by the call section is provided in the center device, and wherein the mutual communication of information is carried out between the radio terminal and the center device using the communication section, and individual information for recording in the radio terminal is sent when required from the center device.

The seventeenth aspect of the present invention is a radio terminal system that a user of a radio terminal uses to perform new subscription contract procedures, contract annulment procedures, and model change procedures with a communication provider, comprising: a radio terminal used by the user; and a center device and authentication device with which the radio terminal communicates via a predetermined radio network, wherein call section for requesting communication with the center device belonging to the communication provider through a predetermined operation performed on the radio terminal using individual information of that radio terminal is provided in the radio terminal, authenticating section for receiving communication requests from the call section, authenticating a call by checking the individual information used by the call section against individual information of the radio terminal managed by the authentication device, and connecting the call from the radio terminal to the center device via the predetermined radio network is provided in the authentication device, and communication section for communicating with the radio terminal to which the center device has been connected via the radio network by the authenticating section is provided in the center device, and wherein the mutual communication of information is carried out between the radio terminal and the center device using the communication section, and individual information for recording in the radio terminal is sent when required from the center device.

According to the present invention, because the user of a radio terminal is able to perform the procedures for entering into a temporary contract for a new subscription and also switching to a formal contract, and also perform the procedures for annulling a contract or changing the model of radio terminal he or she is using while using the radio terminal to communicate with a center station, there is no longer any need for the communication provider to open even more designated customer service counters in order to receive more new subscribers for radio terminals allowing the costs that arise when new designated customer service counters are opened to be kept in check. Moreover, the need for a user to make a special visit to a designated customer service counter located at some distance from the users home in cases when the user does not live near a designated customer service counter no longer exists. The user is now able to perform the procedures for a new subscription or the like at any time provided that radio wave conditions in the communication service area of the communication provider are satisfactory.

When the calling number registered in advance in the radio terminal is a dummy calling number, no missing numbers are created among the calling numbers allocated to the communication provider even, for example, if the procedure for a new subscription is not performed for the radio terminal. Accordingly, the communication provider is able to use effectively the calling numbers the resources of which are limited.

Furthermore, because the open communication key and contract annulment key as well as the model change key used in the above various procedures are made known by the communication provider through means other than being communicated via the radio terminal of the user, it is possible to confirm that the identity of the user who performs the various procedures described above is the same as that of the user described in the actual contract information.

### BRIEF DESCRIPTION OF DRAWINGS

FIG. 1 is a diagram showing the structure of the radio terminal system according to the embodiment of the present invention.

FIG. 2 is a diagram showing an example of the contents of the user database D1.

FIG. 3 is a diagram showing an example of the contents of the open communication key database D3.

FIG. 4 is a diagram showing an example of the contents of the contract annulment key database D4.

FIG. 5 is a diagram showing an example of the contents of the model change key database D5.

FIG. 6 is a sequence chart showing the sequence of the contract procedure for a new subscription (temporary contract).

FIG. 7 is a sequence chart showing the sequence of the contract procedure for a new subscription (transition to a formal contract).

FIG. 8 is a sequence chart showing the sequence of the contract annulment procedure.

FIG. 9 is a sequence chart showing the sequence of the model change procedure (an old terminal operation stopping procedure).

FIG. 10 is a sequence chart showing the sequence of the model change procedure (a new terminal operation starting procedure).

### BEST MODE FOR CARRYING OUT THE INVENTION

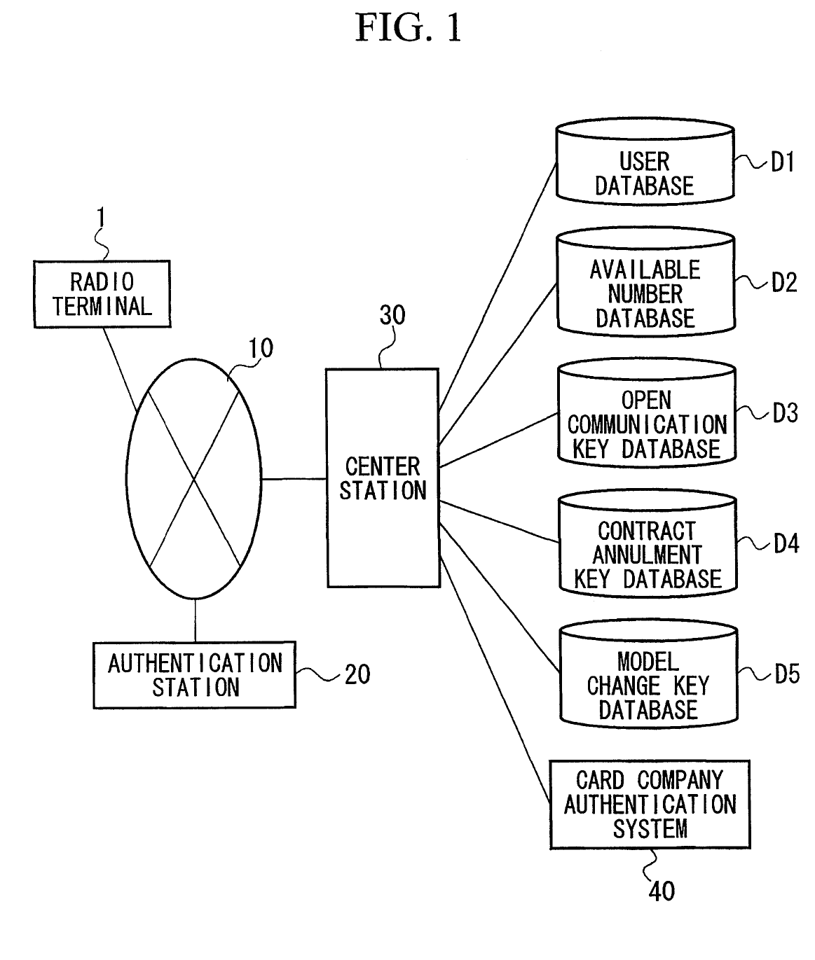

The embodiment of the present invention will now be described with reference to the drawings. Here, the description given uses as an example a case in which the processing to authenticate a call from a radio terminal is carried out by an authentication station. FIG. 1 shows the structure according to an embodiment of the radio terminal system of the present invention. This system is provided with a radio terminal 1 belonging to a user; a center station 30 belonging to a communication provider who collects the considerations that ensue as a result of communication using the radio network 10 by the radio terminal 1; an authentication station 20; a user database D1; an available number database D2; an open communication key database D3; a contract annulment key database D4; a model change key database D5; and a card company authentication system 40.

The radio terminal 1 may be a mobile telephone or PHS or else a computer device or the like capable of carrying out the functions of these. The radio terminal 1 makes a call to the center station 30 via the radio network 10 requesting communication. After this call has been connected, information relating to predetermined procedures is mutually exchanged with the center station 30. In addition, the radio terminal 1 talks to other radio terminals and normal subscription telephones by making a call requesting communication via the radio network 10. Furthermore, at the point of shipping certain information is recorded in the radio terminal 1. This information includes service order data (i.e. information relating to the communication provider, authentication key, priority station designation information, option codes, and individual information such as, for example, the calling number) that is necessary for communicating via the radio network 10, terminal specific information used for identifying the radio terminal 1, and sign up commands that are linked to and activated by predetermined key operations such as, for example, the pressing of numerical keys or icon selection keys displayed on the display screen and that are used for making calls to the center station 30 requesting communication for performing predetermined procedures. For example, the above individual information (calling number) may be a dummy calling number that is only authenticated by the authentication station 20 (described in detail below) when a call is made from the radio terminal 1 to the center station 30.

The authentication station 20 receives a call from the radio terminal 1 requesting communication via the radio network 10. The authentication station 20 checks the calling number and authentication key of the radio terminal 1 that are attached to this call so as to be made known to the authentication station against the calling numbers of the radio terminals 1 managed by the authentication station 20 and the authentication keys corresponding to these calling numbers. If the results of the checks match, the call is authenticated and the call from the radio terminal 1 is connected to a predetermined communication request destination. If the calling number of the radio terminal 1 is a dummy, the authentication station 20 only authenticates calls from the radio terminal 1 to the center station 30. As a result, communication (i.e. telephone calls) with other radio terminals and the like using a radio terminal 1 that has not completed the temporary contract for a new subscription can be prevented.

When the call from a radio terminal 1 is authenticated by the authentication station 20, the call from the radio terminal 1 is connected and the center station 30 performs the mutual communication of information relating to the predetermined procedures. At this time, the center station 30 registers where necessary the above mutually communicated information in databases including the user database D1, the available number database D2, the open communication key database D3, the contract annulment key database D4, and the model change key database D5 and refers to or extracts registration information in the above predetermined databases. Alternatively, the center station 30 may send the registration information in the above databases to the card company authentication system 40 where the authentication processing for the above registration information is performed.

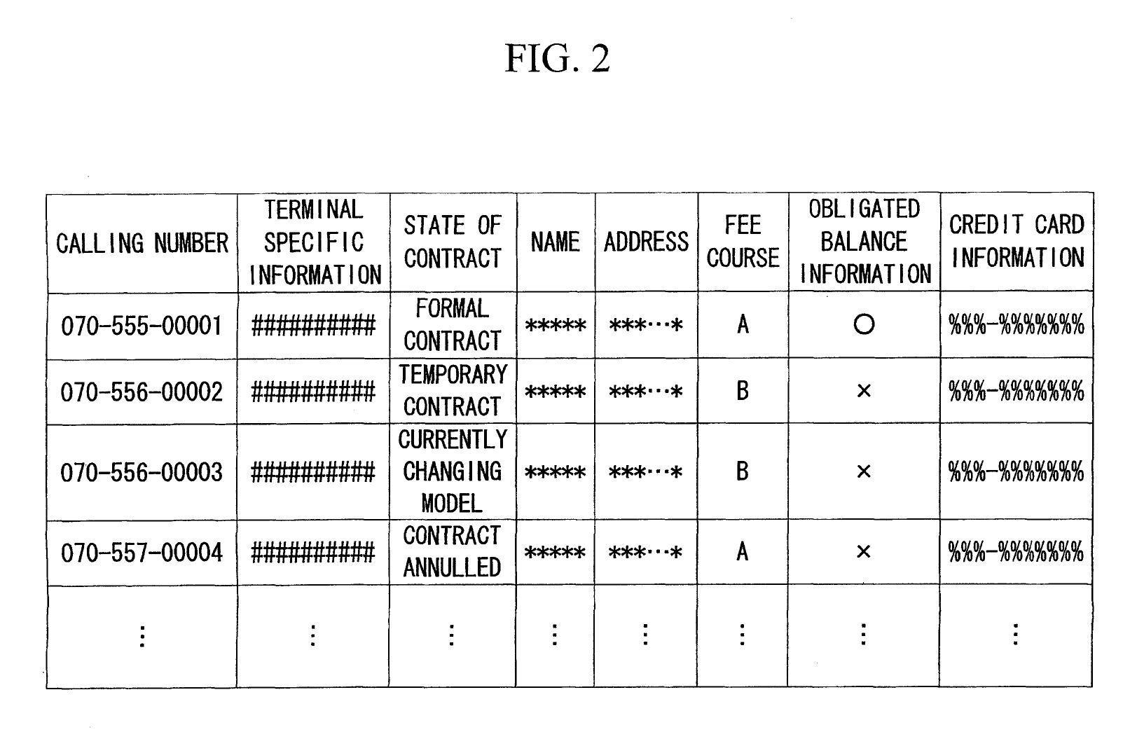

The user database D1 is a database in which information about the user of the radio terminal 1 is registered and is managed by the above communication provider. For example, as is shown in FIG. 2, the user database D1 may include the calling number, terminal specific information, the state of the contract, name, address, fee course, obligated balance information, and credit card information. The calling number refers to numbers that equate to the telephone numbers of radio terminals that are allocated to each communication provider. The terminal specific information is information that identifies each different individual radio terminal 1. The state of the contract is information showing what state the contract is in such as whether the contract is a temporary contract, a formal contract, or annulled, or whether the model of radio terminal is currently being changed. The name and address is information that includes the name and address of the user of the radio terminal 1. The fee course is information showing the type of charge of the communication fee. The obligated balance information shows whether or not there are any uncollected communication fees. The credit card information shows the credit card number. Demands by the communication provider for payment of the communication fee by the user are made based on the user database D1.

The available number database D2 is extracted from the user database D1. The database D2 comprises the remaining numbers when those calling numbers that have already been allocated to radio terminals are removed from the total number of calling numbers that were allocated to the communication provider. The calling numbers shown in the available number database D2 are those calling numbers that can be allocated to the radio terminals of new subscriptions. In addition, the numbers in the available number database D2 may be substituted by extracting from the user database D1 and then sorting only those calling numbers that have not been allocated to a radio terminal 1.

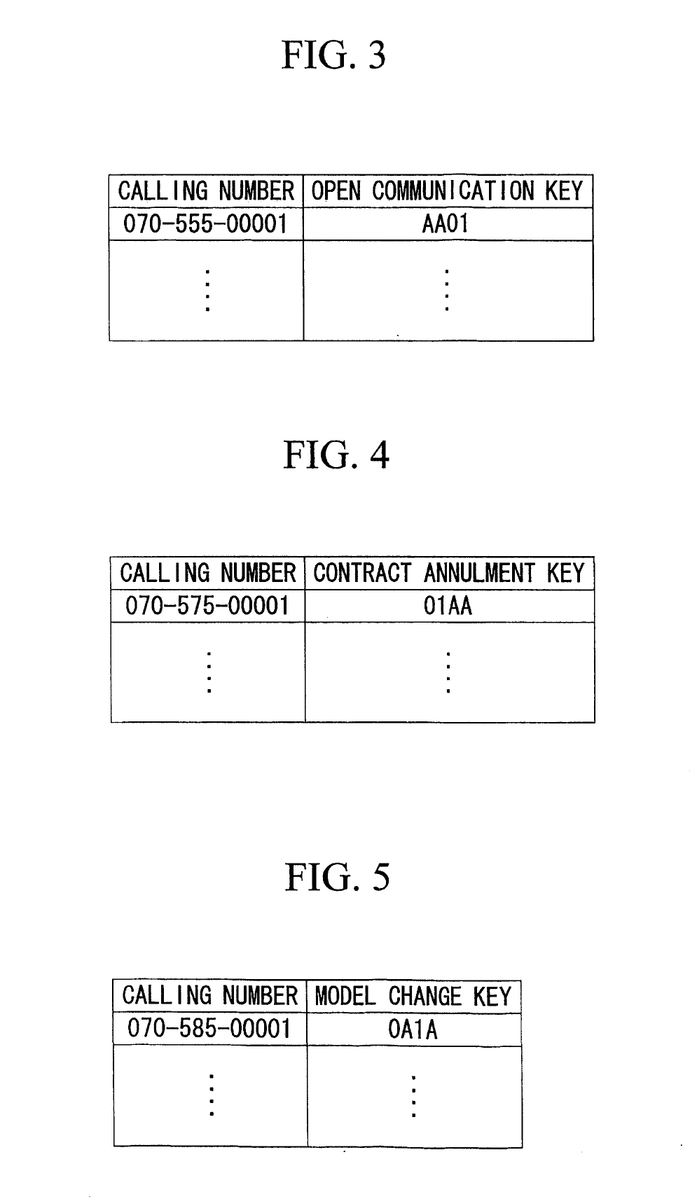

The open communication key database D3 is a database in which are registered the open communication keys that are necessary for performing the procedure to change from a temporary contract for a new subscription to a formal contract. One open communication key is set by the center station 30 for the calling number of one radio terminal 1 of a user still under a temporary contract. For example, as is shown in FIG. 3, the open communication key “AA01” is set for the calling number “070-555-00001”. This set open communication key is made known to the user by the communication provider based on the user information (i.e. name, address) in the user database D1.

The contract annulment database D4 is a database in which the contract annulment keys that are necessary for performing the contract annulment procedure are registered. If a user applies in advance to the communication provider for a contract to be annulled, then one contract annulment key is set by the center station 30 for the calling number of one radio terminal 1 of the user. For example, as is shown in FIG. 4, the contract annulment key “01AA” is set for the calling number “070-575-00001”. The set contract annulment key is made known to the user by the communication provider based on the user information in the user database D1.

The model change key database D5 is a database in which are registered the model change keys that are required for performing the model change procedure. If a user applies in advance to the communication provider for a change of model, then one model change key is set by the center station 30 for the calling number of one radio terminal 1 of the user. For example, as is shown in FIG. 5, the model change key “0A1A” is set for the calling number “070-585-00001”. The set model change key is made known to the user by the communication provider based on the user information in the user database D1.

The card company authentication system 40 receives from the center station 30 registration information relating to the credit card of the user, for example, the credit card number and the name of the user communicated through a predetermined procedure. The legality of the user is then authenticated by the card company authentication system 40 checking the registered information and the above registered information managed by the card company authentication system 40 against each other.

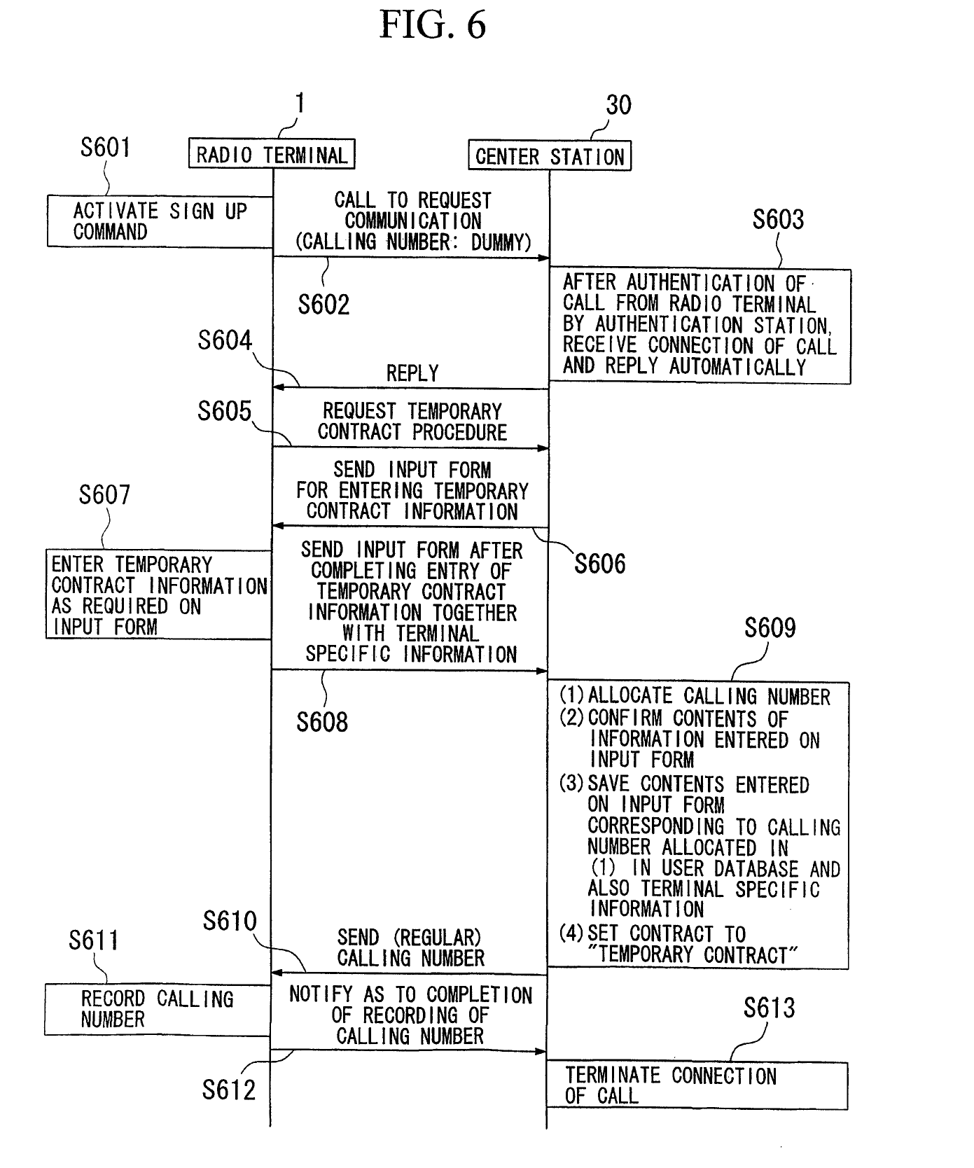

Next, a detailed description will be given of the sequence of the predetermined procedures performed between the center station 30 and the radio terminal 1 according to the present embodiment with reference made to the sequence charts in FIGS. 6 to 10 and to FIGS. 1 to 5 where necessary.

1. Contract Procedures (Temporary Contract) For a New Subscription

FIG. 6 is a sequence chart showing the sequence of the contract procedure (a temporary contract) for a new subscription. A user activates a sign up command to start the temporary contract procedure by performing a predetermined operation with the radio terminal 1, for example, pressing the numerical key “1” (step S601). Using a dummy calling number, the radio terminal 1 makes a call requesting communication to the center station 30 (step S602). The center station 30 receives notification that the authentication station 20 has authenticated the call requesting communication and the call has been connected and replies automatically (step S603). A reply to the call requesting communication is then transmitted (step S604). When it receives this reply the radio terminal 1 issues a request for the temporary contract procedure based on the sign up command (step S605). The center station 30 then transmits an input form for entering predetermined temporary contract information (step S606). Note that this temporary contract information is information corresponding to the information in the user database D1, for example, information that includes the name of the user, his or her address, the fee course, and credit card number. The user enters the predetermined temporary contract information on the received input form using the radio terminal 1 (step S607), and then the input form on which all the entries have been filled in is transmitted together with the terminal specific information from the radio terminal 1 to the center station 30 (step S608). The center station 30 then executes the processes (1) to (4) below based on the received temporary contract information and the terminal specific information (step S609).

(1) Referring to the available number database D2, the center station 30 allocates an calling number that corresponds to the terminal specific information of the radio terminal 1 (step S609—(1)).

(2) The center station 30 then confirms whether or not any entries have been left not filled in from among the contents of the required information entered on the input form and also transmits the credit card number information to the card company authentication system 40 for examination (step S609—(2)).

(3) Referring to the user database D1, the center station 30 registers the contents of the terminal specific information and the required information that have been entered on the input form corresponding to the calling number allocated in step S609—(1) so as to correspond to the relevant items in the user database D1 (step S609—(3)).

(4) Referring to the user database D1, the center station 30 sets the category of the state of the contract for the calling number allocated in step S609—(1) to “Temporary Contract” (step S609—(4)).

After the above processing has been performed the center station 30 transmits the allocated calling number (step S610) and the radio terminal 1 records the calling number as the regular calling number (step S611). The radio terminal 1 confirms that the recording of the calling number has been completed and sends a notification of the completion to the center station 30 (step S612). Upon receiving the completion notification, the center station 30 terminates the connection of the call with the radio terminal 1 (step S613). After the completion of the temporary contract procedure by communication with the radio terminal 1, the center station 30 sets the open communication key so as to correspond to the allocated calling number described above while referring to the open communication key database D3 (see FIG. 3). Here, the open communication key “AA01” is set for the calling number “070-555-00001”. Note that in cases when the conditions given below are met, the above procedure is terminated and the sequence begins again from the start.

(1) If there is an uncompleted entry in step S609—(2).

(2) If there is no authentication resulting from the examination by the card company authentication system in step S609—(1).

(3) If there is any obstacle to the functioning of the radio terminal 1 or the functioning of the center station 30, or if the above sequence does not end normally due to reasons such as obstacles to communication being created by the radio network.

2. Contract Procedures (i.e. For Changing to a Formal Contract) For a New Subscription

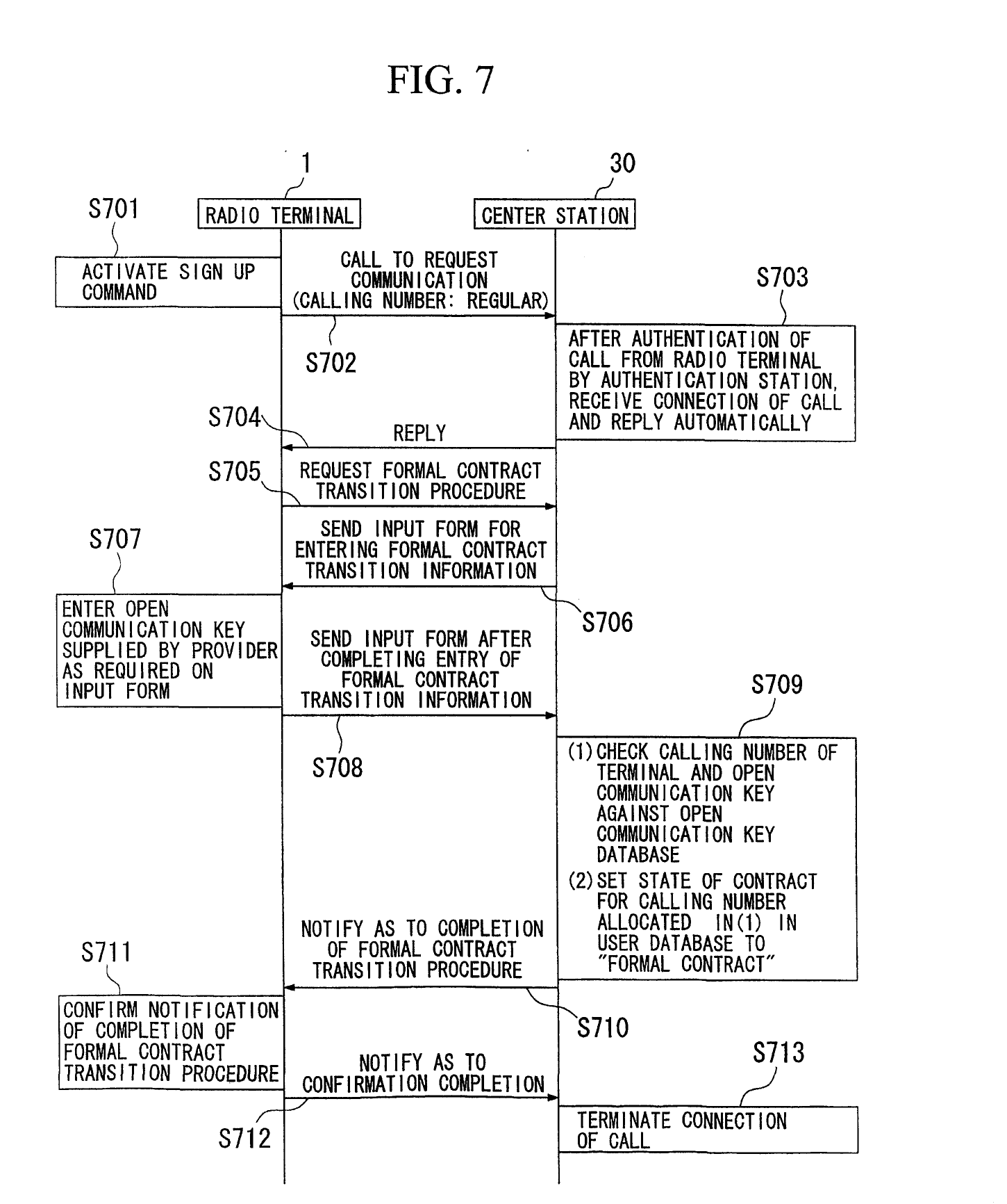

FIG. 7 is a sequence chart showing the sequence of the contract procedure (changing to a formal contract) for a new subscription. When performing the procedure to change to a formal contract, a user requires an open communication key that the communication provider sends to the user by letter or the like after the completion of the above temporary contract procedure. The user activates a sign up command to start the procedure to change to a formal contract by performing a predetermined operation with the radio terminal 1, for example, pressing the numerical key “2” (step S701). Using the regular calling number recorded in the temporary contract, the radio terminal 1 makes a call requesting communication to the center station 30 (step S702). The center station 30 receives notification that the call requesting communication has been authenticated by the authentication station 20 and the connection of the call has been made and replies automatically (step S703). A reply to the call requesting communication is then transmitted (step S704). When it receives this reply the radio terminal 1 issues a request for the procedure to change to a formal contract based on the sign up command (step S705). The center station 30 then transmits an input form for entering predetermined information for changing to a formal contract (step S706). Note that, this information for changing to a formal contract comprises the open communication key that was given to the user by the communication provider. The user enters the predetermined open communication key on the received input form using the radio terminal 1 (step S707), and then the input form on which all the entries have been filled in is transmitted from the radio terminal 1 to the center station 30 (step S708). The center station 30 then executes the processes (1) and (2) below based on the received open communication key (step S709).

(1) Referring to the open communication key database D3, the center station 30 checks the information in this database against the received open communication key and calling number of the radio terminal 1 (step S709—(1)).

(2) Referring to the user database D1, the center station 30 sets the category of the state of the contract that corresponds to the calling number of the radio terminal 1 to “Formal Contract” (step S709—(2)).

After the above processing, the center station 30 transmits notification that the procedure to change to a formal contract has been completed (step S710). The radio terminal 1 confirms the notification that the procedure to change to a formal contract has been completed (step S711) and sends notification of the completion of the confirmation to the center station 30 (step S712). Upon receiving notification of the completion of the confirmation, the center station 30 terminates the connection of the call with the radio terminal 1 (step S713). Note that in cases when the conditions given below are met, the above procedure is terminated and the sequence begins again from the start.

(1) If the results of the check in step S709—(1) do not match.

(2) If there is any obstacle to the functioning of the radio terminal 1 or the functioning of the center station 30, or if the above sequence does not end normally due to reasons such as obstacles to communication being created by the radio network.

3. Contract Annulment Procedures

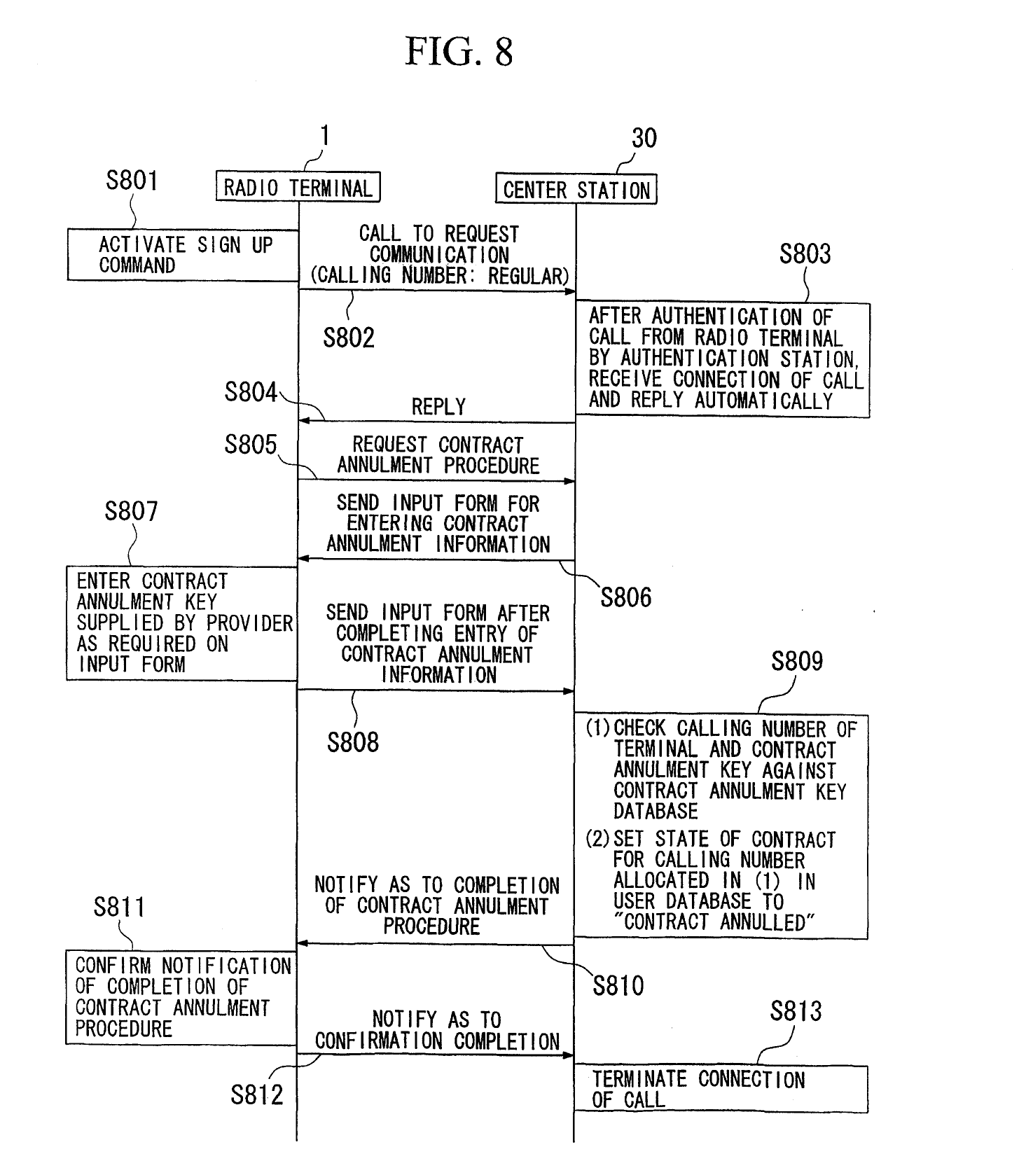

FIG. 8 is a sequence chart showing the sequence of the contract annulment procedure. When performing the procedure to annul a contract, a user requires an contract annulment key that the communication provider sends to the user by letter or the like after the user has given prior notice about the contract annulment to the communication provider. The user activates a sign up command to start the contract annulment procedure by performing a predetermined operation with the radio terminal 1, for example, pressing the numerical key “3” (step S801). Using the regular calling number the radio terminal 1 makes a call requesting communication to the center station 30 (step S802). The center station 30 receives notification that the call requesting communication has been authenticated by the authentication station 20 and the connection of the call has been made and replies automatically (step S803). A reply to the call requesting communication is then transmitted (step S804). When it receives this reply the radio terminal 1 issues a request for the contract annulment procedure based on the sign up command (step S805). The center station 30 then transmits an input form for entering predetermined formal contract annulment information (step S806). Note that, this contract annulment information comprises the contract annulment key that was given to the user by the communication provider. The user enters the predetermined contract annulment key on the received input form using the radio terminal 1 (step S807), and then the input form on which all the entries have been filled in is transmitted from the radio terminal 1 to the center station 30 (step S808). The center station 30 then executes the processes (1) and (2) below based on the received contract annulment key (step S809).

(1) Referring to the contract annulment key database D4, the center station 30 checks the information in this database against the received contract annulment key and calling number of the radio terminal 1 (step S809—(1)).

(2) Referring to the user database D1, the center station 30 sets the category for the state of the contract that corresponds to the calling number of the radio terminal 1 to “Contract Annulled” (step S809—(2)).

After the above processing, the center station 30 transmits notification that the contract annulment procedure has been completed (step S810). The radio terminal 1 confirms the notification that the contract annulment procedure has been completed (step S811) and sends notification of the completion of the confirmation to the center station 30 (step S812). Upon receiving the confirmation completion notification, the center station 30 terminates the connection of the call with the radio terminal 1 (step S813). Note that in cases when the conditions given below are met, the above procedure is terminated and the sequence begins again from the start.

(1) If the results of the check in step S809—(1) do not match.

(2) If there is any obstacle to the functioning of the radio terminal 1 or the functioning of the center station 30, or if the above sequence does not end normally due to reasons such as obstacles to communication being created by the radio network.

4. Model Change Procedure (Old Terminal Operation Stopping Procedure)

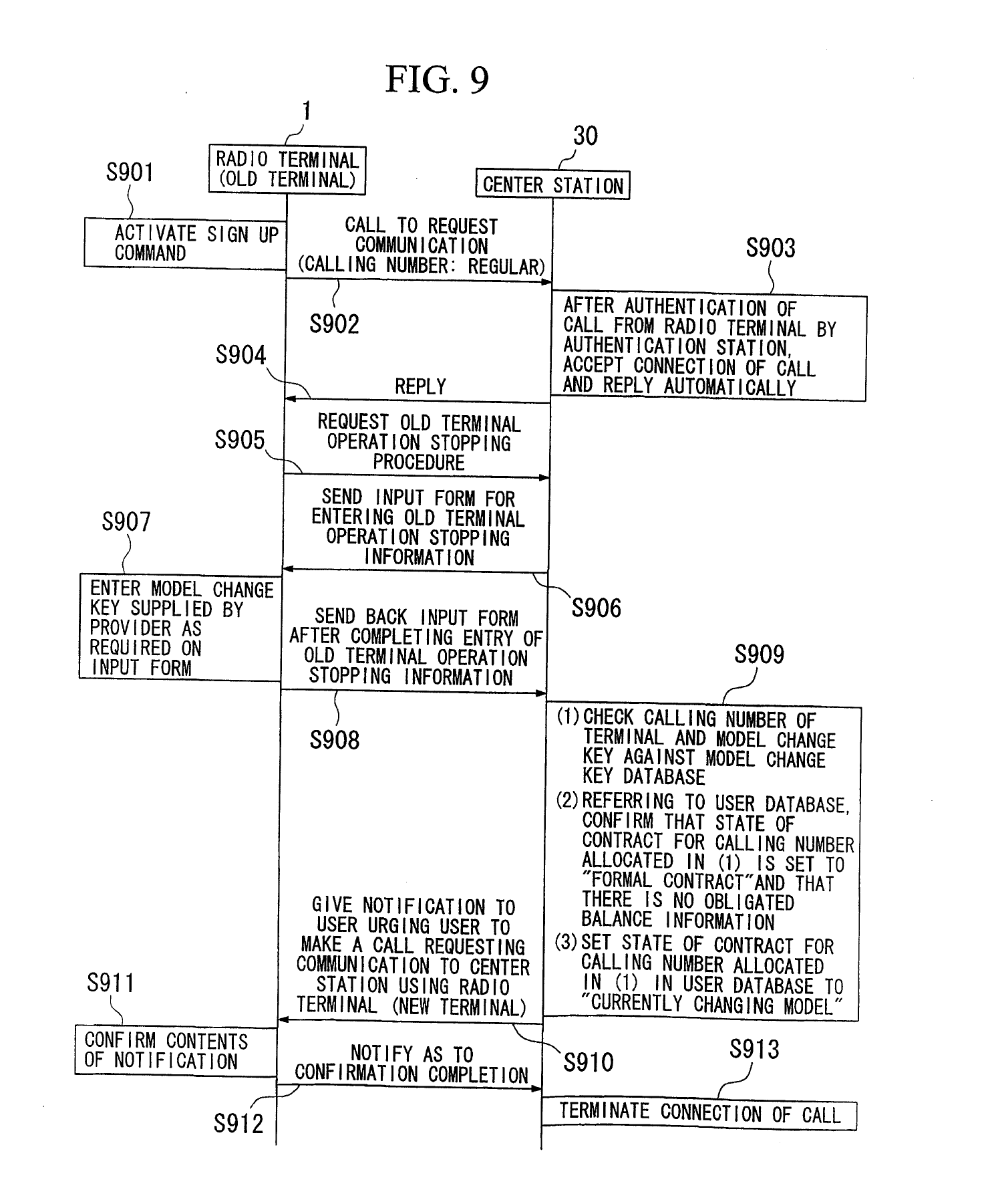

FIG. 9 is a sequence chart showing the sequence of the model change procedure (i.e. an old terminal operation stopping procedure). When performing the procedure to stop the operation of an old terminal, a user requires a model change key that the communication provider sends to the user through the post or the like after the user has given prior notice about the model change to the communication provider. The user activates a sign up command to start the old terminal operation stopping procedure by performing a predetermined operation with the radio terminal 1 belonging to the user prior to changing the model (referred to below as “old terminal 1”), for example, pressing the numerical key “4” (step S901). Using the calling number the old terminal 1 makes a call requesting communication to the center station 30 (step S902). The center station 30 receives notification that the authentication station 20 has authenticated the call requesting communication and that the call has been connected and replies automatically (step S903). A reply to the call requesting communication is then transmitted (step S904). When it receives this reply the old terminal 1 issues a request for the old terminal operation stopping procedure based on the sign up command (step S905). The center station 30 then transmits an input form for entering predetermined old terminal operation stopping information (step S906). Note that this old terminal operation stopping information comprises the model change key that was given to the user by the communication provider. The user enters the predetermined model change key on the received input form using the old terminal 1 (step S907), and then the input form on which all the entries have been filled in is transmitted from the old terminal 1 to the center station 30 (step S908). The center station 30 then executes the processes (1) to (3) below based on the received model change key (step S909).

(1) Referring to the model change key database DS, the center station 30 checks the information in this database against the received model change key and calling number of the old terminal 1 (step S909—(1)).

(2) Referring to the user database D1, the center station 30 confirms that the category for the state of the contract that corresponds to the calling number of the old terminal 1 is set at “Formal Contract” and that there is no information about any obligated balance fees (step S909—(2)).

(3) Referring to the user database D1, the center station 30 sets the category for the state of the contract that corresponds to the calling number of the old terminal 1 to “Currently Changing Model” (step S909—(3)).

After the above processing, the center station 30 sends a notification urging the user to make a call requesting communication to the center station using the radio terminal 1 after the model has been changed (this will be referred to below as the “new terminal 1”) (step S910). The old terminal 1 confirms the contents of this notification (step S911) and sends notification of the completion of the confirmation to the center station 30 (step S912). Upon receiving the confirmation completion notification, the center station 30 terminates the connection of the call with the old terminal 1 (step S913). At this point the old terminal 1 becomes no longer usable. Note that in cases when the conditions given below are met, the above procedure is terminated and the sequence begins again from the start.

(1) If the results of the check in step S909—(1) do not match.

(2) If the state of the contract in step S909—(2) is not set to “Formal Contract”, or if there is information pertaining to any obligated balance fees.

(3) If there is any obstacle to the functioning of the radio terminal 1 or the functioning of the center station 30, or if the above sequence does not end normally due to reasons such as obstacles to communication being created by the radio network.

5. Model Change Procedure (New Terminal Operation Starting Procedure)

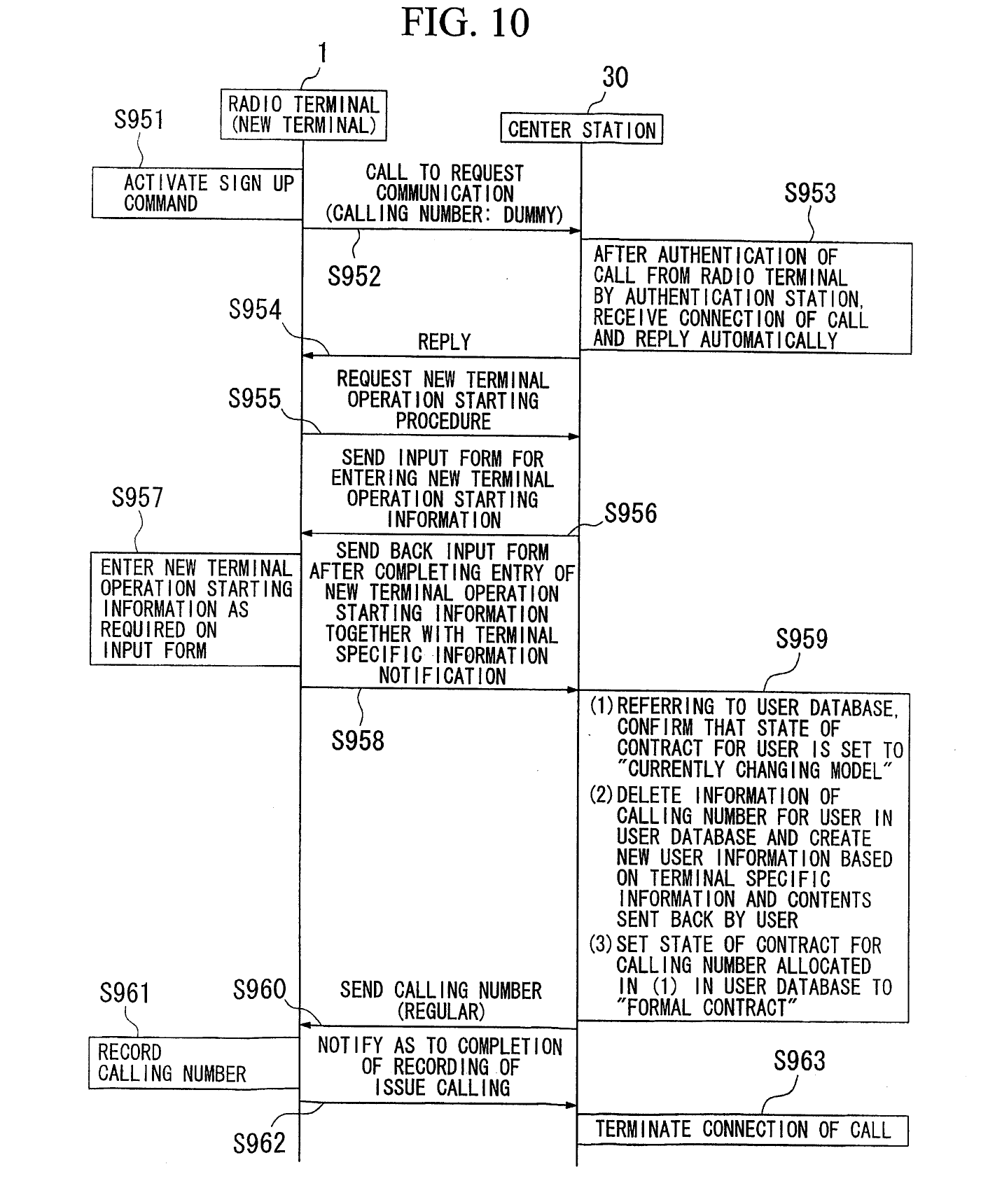

FIG. 10 is a sequence chart showing the sequence of the model change procedure (i.e. a new terminal operation starting procedure). When performing the procedure to start the operation of a new terminal, the radio terminal 1 after the model was changed when the old terminal operation stopping procedure was performed is used (this will be referred to below as “new terminal 1”).

The user activates a sign up command to start the model change procedure by performing a predetermined operation with the new terminal 1, for example, pressing the numerical key “5” (step S951). Using a dummy calling number the radio terminal (i.e. the new terminal) 1 makes a call requesting communication to the center station 30 (step S952). The center station 30 receives notification that the call requesting communication has been authenticated by the authentication station 20 and the connection of the call has been made and replies automatically (step S953). A reply to the call requesting communication is then transmitted (step S954). When it receives this reply the new terminal 1 issues a request for the new terminal operation starting procedure based on the sign up command (step S955). The center station 30 then transmits an input form for entering predetermined new terminal operation starting information (step S956). Note that this new terminal operation starting information comprises information corresponding to the user database D1, for example, information that includes the name and address of the user, the fee course, and the credit card number. The user enters the predetermined new terminal operation starting information on the received input form using the new radio terminal 1 (step S957), and then the input form on which all the entries have been filled in is transmitted together with terminal specific information from the new terminal 1 to the center station 30 (step S958). The center station 30 then executes the processes (1) to (3) below based on the received new terminal operation starting information and terminal specific information (step S959).

(1) Referring to the user database D1, the center station 30 confirms that the state of the contract of the user who corresponds to the required information entered in the input form is set at “Currently Changing Model” (step S959—(1)).

(2) Referring to the user database D1, the center station 30 deletes the calling number of the user who corresponds to the required information entered in the input form and registers new user information in the database based on the newly input required information. Note that the calling number is the same as for the old terminal (step S959—(2)).

(3) Referring to the user database D1, the center station 30 sets the category for the state of the contract that corresponds to this calling number to “Formal Contract” (step S959—(3)).

After the above processing, the center station 30 transmits this calling number (step S960) and the new terminal 1 records this calling number as the regular calling number (step S961). The new radio terminal 1 confirms the completion of the recording of this calling number and sends notification of the completion to the center station 30 (step S962). Upon receiving the completion notification, the center station 30 terminates the connection of the call with the new radio terminal 1 (step S963). Note that in cases when the conditions given below are met, the above procedure is terminated and the sequence begins again from the start.

(1) If the state of the contract in step S959—(1) is not set at “Currently Changing Model”.

(2) If there are any uncompleted entries in step S959—(2).

(3) If no authentication is made in the examination by the card company authentication system in step S959—(2).

(4) If there is any obstacle to the functioning of the radio terminal 1 or the functioning of the center station 30, or if the above sequence does not end normally due to reasons such as obstacles to communication being created by the radio network.

Note that the present invention is not limited to the above described embodiment and variations thereof are of course possible in so far as they do not deviate from the intent of the invention. For example, in the present embodiment a description is given for when the radio terminal 1 is a mobile telephone or PHS or else a computer device capable of carrying out the functions of these, however, the present invention is not limited to these and a data communication terminal capable of performing the functions of a mobile telephone or PHS may also be used.

Furthermore, in the new subscription contract procedure and model change procedures in the present embodiment, a description is given of when a call is made to the center station 30 using a dummy calling number registered in advance in the radio terminal 1 and communication is made possible when the call is connected to the center station 30 after the call has been authenticated by the authentication station 20, however, the present invention is not limited to this and it is also possible for a call to be made to the center station 30 using a normal calling number, or for the call between the radio terminal 1 and the center station 30 to be connected without authentication being made by the authentication station 20.

Moreover, if the procedure to switch to a formal contract has not been performed even after a predetermined time has passed since the temporary contract procedure for a new subscription was performed, it is possible to prohibit the use of the radio terminal 1, and even in cases in which a user has made a temporary contract for a radio terminal 1 using incorrect information, it is possible for the losses borne by the communication provider through the use of this radio terminal 1 to be minimized. In addition, in the temporary contract procedure it is also possible for information equivalent to this period to be sent from the center station 30 and registered in the radio terminal 1.

Moreover, in the present embodiment a description is given of when the user information in the user database D1 referred to by the center station 30 comprise the categories of calling number, terminal specific information, the state of the contract, the user name, the user address, the fee course, obligated balance information, and credit card information, however, the present invention is not limited to this and it is also possible to add categories relating to the interests and tastes of the user to the above categories. In this case, it is possible for information to the user to be provided from the communication provider based on the above information.

In addition, the use of the card company authentication system 40 is not limited to being applied to credit cards and it is also possible for the card company authentication system 40 to be used with bank cash cards as well. In this case, the user doers not need to enter into a contract with a credit card company.

### INDUSTRIAL APPLICABILITY

A radio terminal contract procedure method and radio terminal system are provided that enable contract procedures to be carried out and also enable contract annulment and model change procedures to be carried out with a communication provider using the radio terminal purchased by a user.

1. A radio terminal procedure method for a user of a radio terminal to perform a procedure for a contract for a new subscription with a communication provider, wherein
the contract procedure comprises a temporary contract procedure and a formal contract transition procedure that uses information to make a transition to a formal contract that is made known by the communication provider after the temporary contract procedure, wherein
the temporary contract procedure comprises:
a call process in which the radio terminal makes a call requesting communication with a center device belonging to the communication provider based on a predetermined operation performed using the radio terminal; and
a temporary contract process in which mutual communication between the radio terminal and the center device via a predetermined radio network is made possible by the call process, and temporary contract information is sent from the radio terminal to the center device and the individual information sent from the center device is registered, and wherein
the formal contract transition procedure comprises:
a call process in which the radio terminal makes a call requesting communication with the center device based on a predetermined operation performed using the radio terminal; and
a formal contract transition process in which mutual communication between the radio terminal and the center device via the predetermined radio network is made possible by the call process, and formal contract transition information that includes individual information is sent from the radio terminal to the center device and a transition is made from the temporary contract to a formal contract.

2. A radio terminal procedure method for a user of a radio terminal to perform a contract annulment procedure with a communication provider, wherein
the contract annulment procedure comprises:
a call process in which the radio terminal makes a call requesting communication with a center device belonging to the communication provider based on a predetermined operation performed using the radio terminal; and
a contract annulment process in which mutual communication between the radio terminal and the center device via a predetermined radio network is made possible by the call process, and contract annulment information is sent from the radio terminal to the center device and the contract is annulled.

3. A radio terminal procedure method for a user of a radio terminal to perform a model change procedure with a communication provider, wherein
the model change procedure comprises:
an old terminal operation stopping procedure for stopping use of a radio terminal that has been used prior to the change of model; and
a new terminal operation starting procedure for starting use of the changed model of radio terminal after the old terminal operation stopping procedure has been performed, wherein
the old terminal operation stopping procedure comprises:
a call process in which the radio terminal before the model change makes a call requesting communication with a center device belonging to the communication provider based on a predetermined operation performed using the radio terminal; and
an old terminal operation stopping process in which mutual communication between the radio terminal before the model change and the center device via a predetermined radio network is made possible by the call process, and old terminal operation stopping information is sent from the radio terminal before the model change to the center device and use of the radio terminal before the model change is stopped, and wherein
the new terminal operation starting procedure comprises:
a call process in which the changed model of radio terminal makes a call requesting communication with the center device based on a predetermined operation performed using the radio terminal; and
a new terminal operation starting process in which mutual communication between the changed model of radio terminal and the center device via the predetermined radio network is made possible by the call process, and new terminal operation starting information is sent from the changed model of radio terminal to the center device and individual information of the radio terminal before the model change sent from the center device is registered in the changed model of radio terminal.

4. A radio terminal procedure method for a user of a radio terminal to perform a procedure for a contract for a new subscription with a communication provider, wherein
the contract procedure comprises a temporary contract procedure and a formal contract transition procedure that uses information for making a transition to a formal contract that is made known by the communication provider after the temporary contract procedure, wherein
the temporary contract procedure comprises:
a call process in which the radio terminal makes a call requesting communication with a center device belonging to the communication provider based on a predetermined operation performed using the radio terminal and makes known predetermined individual information of the radio terminal by attaching the predetermined individual information to the call;
an authentication process in which authentication is made by the individual information made known in the call process being checked against individual information of the radio terminal managed by an authentication device and in which the call from the radio terminal is then connected to the center device via a predetermined radio network; and
a temporary contract process in which mutual communication between the radio terminal and the center device is made possible by the connection of the call, and temporary contract information is sent from the radio terminal to the center device and individual information newly sent from the center device is registered based on the temporary contract information, and wherein
the formal contract transition procedure comprises:
a call process in which the radio terminal makes a call requesting communication with the center device based on a predetermined operation performed using the radio terminal and makes known the individual information newly registered in the temporary contract process by attaching this newly registered individual information to the call;
an authentication process in which authentication is made by the individual information made known in the call process being checked against individual information of the radio terminal managed by the authentication device and in which the call from the radio terminal is then connected to the center device via the predetermined radio network; and
a formal contract transition process in which mutual communication between the radio terminal and the center device is made possible by the connection of the call, and formal contract transition information is sent from the radio terminal to the center device and the temporary contract is changed to a formal contract.

5. A radio terminal procedure method for a user of a radio terminal to perform a contract annulment procedure with a communication provider, wherein
the contract annulment procedure comprises:
a call process in which the radio terminal makes a call requesting communication with a center device belonging to the communication provider based on a predetermined operation performed using the radio terminal and makes known predetermined individual information of the radio terminal by attaching the predetermined individual information to the call;
an authentication process in which authentication is made by the individual information made known in the call process being checked against individual information of the radio terminal managed by an authentication device and in which the call from the radio terminal is then connected to the center device via a predetermined radio network; and
a contract annulment process in which mutual communication between the radio terminal and the center device is made possible by the connection of the call, and contract annulment information is sent from the radio terminal to the center device and the contract is annulled.

6. A radio terminal procedure method for a user of a radio terminal to perform a model change procedure with a communication provider, wherein
the model change procedure comprises:
an old terminal operation stopping procedure for stopping use of a radio terminal that has been in use prior to the model change; and
a new terminal operation starting procedure for starting use of the changed model of radio terminal after the old terminal operation stopping procedure has been performed, wherein
the old terminal operation stopping procedure comprises:
a call process in which the radio terminal before the model change makes a call requesting communication with a center device belonging to the communication provider based on a predetermined operation performed using the radio terminal and makes known predetermined individual information of the radio terminal by attaching the predetermined individual information to the call;
an authentication process in which authentication is made by the individual information made known in the call process being checked against individual information of the radio terminal managed by an authentication device and in which the call from the radio terminal is then connected to the center device via a predetermined radio network; and
an old terminal operation stopping process in which mutual communication between the radio terminal and the center device is made possible by the connection of the call, and old terminal operation stopping information is sent from the radio terminal to the center device and use of the radio terminal prior to the model change is stopped, and wherein
the new terminal operation starting procedure comprises:
a call process in which a call requesting communication with the center device is made based on a predetermined operation performed using the radio terminal after the model is changed, and predetermined individual information of the radio terminal is made known by being attached to the call;
an authentication process in which authentication is made by the individual information made known in the call process being checked against individual information of the radio terminal managed by the authentication device and in which the call from the radio terminal is then connected to the center device via the predetermined radio network; and
a new terminal operation starting process in which mutual communication between the radio terminal and the center device is made possible by the connection of the call, and model change information is sent from the radio terminal to the center device and individual information of the radio terminal before the model change sent from the center device is registered in the changed model of radio terminal.

7. The radio terminal procedure method according to any of claims 1 to 6, wherein, in the call process, the call requesting communication is made to the center device by a sign up command activated based on a predetermined operation performed using the radio terminal.

8. The radio terminal procedure method according to any of claims 4 to 6, wherein the individual information of the radio terminal includes a calling number and information managed by the authentication device or the center device, and the calling number is an calling number sent by the center device and registered or a dummy calling number registered in advance in the radio terminal.

9. The radio terminal procedure method according to claim 1 or 4, wherein the formal contract transition information includes an open communication key that is necessary for performing the formal contract transition procedure and is made known by the communication provider by means other than communication using the radio terminal.

10. The radio terminal procedure method according to claim 2 or 5, wherein the contract annulment information includes a contract annulment key that is necessary for performing the contract annulment procedure and is made known by the communication provider by means other than communication using the radio terminal.

11. The radio terminal procedure method according to claim 3 or 6, wherein the old terminal operation stopping information includes a model change key that is necessary for performing the model change procedure and is made known by the communication provider by means other than communication using the radio terminal.

12. The radio terminal procedure method according to any of claims 1 to 6, wherein predetermined information sent from the radio terminal to the center device fills in a predetermined input form sent from the center device and is entered by the user using the radio terminal.

13. A center device used in a radio terminal procedure method for a user of a radio terminal to perform a procedure for a contract for a new subscription with a communication provider, comprising:
communication section for communicating mutually with a radio terminal to which it is connected via a predetermined radio network;
contract information requesting section that uses the communication section to receive requests for a temporary contract procedure or a formal contract transition procedure sent from the radio terminal and to request the radio terminal for predetermined contract information in accordance with the received requests;
temporary contract section that receives predetermined contract information sent from the radio terminal using the contract information requesting section and when the received contract information is temporary contract information, based on the temporary contract information, acquires individual information from a predetermined database, records the temporary contract information in the database, and sends individual information to be recorded in the radio terminal;
formal contract transition section that receives predetermined contract information sent from the radio terminal using the contract information requesting section and when the received contract information is formal contract transition information, checks the formal contract transition information against information registered in a predetermined database; and
open communication key setting section that, after the sending of the individual information to the radio terminal by the temporary contract section, sets an open communication key for use in a formal contract transition procedure that corresponds to the individual information and records the open communication key in a predetermined database.

14. A center device used in a radio terminal procedure method for a user of a radio terminal to perform a contract annulment procedure with a communication provider, comprising:
contract annulment key setting section that, based on an application from the user of the radio terminal to annul the contract, sets in advance a contract annulment key for use in a contract annulment procedure that corresponds to the individual information of the radio terminal and records the contract annulment key in a predetermined database;
communication section for communicating mutually with the radio terminal to which it is connected via a predetermined radio network;
contract information requesting section that uses the communication section to receive requests for a contract annulment procedure sent from the radio terminal and to request the radio terminal for contract annulment information in accordance with the received requests;
contract annulment section that receives the contract annulment information sent from the radio terminal using the contract information requesting section and checks the received contract annulment information against information recorded in a predetermined database.

15. A center device used in a radio terminal procedure method for a user of a radio terminal to perform a model change procedure with a communication provider, comprising:
model change key setting section that, based on an application from the user of the radio terminal to change the model of radio terminal, sets in advance a model change key for use in a model change procedure that corresponds to the individual information of the radio terminal and records the model change key in a predetermined database;
communication section for communicating mutually with the radio terminal to which it is connected via a predetermined radio network;
model change information requesting section that uses the communication section to receive requests for an old terminal operation stopping procedure or a new terminal operation starting procedure sent from the radio terminal and to request the radio terminal for predetermined model change information in accordance with the received requests;
old terminal operation stopping section that receives the predetermined model change information sent from the radio terminal using the model change information requesting section and when the received model change information is old terminal operation stopping information, checks this old terminal operation stopping information against information registered in a predetermined database; and
new terminal operation starting section that receives the predetermined model change information sent from the radio terminal using the model change information requesting section and when the received model change information is new terminal operation starting information, based on this new terminal operation starting information, registers the new terminal operation starting information in a predetermined database and sends individual information to be recorded in the radio terminal.

16. A radio terminal system that a user of a radio terminal uses to perform new subscription contract procedures, contract annulment procedures, and model change procedures with a communication provider, comprising:
a radio terminal used by the user; and
a center device with which the radio terminal communicates via a predetermined radio network, wherein
call section for requesting communication with the center device belonging to the communication provider through a predetermined operation performed on the radio terminal is provided in the radio terminal, and
communication section for communicating with the radio terminal to which the center device has been connected via the predetermined radio network by the call section is provided in the center device, and wherein
the mutual communication of information is carried out between the radio terminal and the center device using the communication section, and
individual information for recording in the radio terminal is sent when required from the center device.

17. A radio terminal system that a user of a radio terminal uses to perform new subscription contract procedures, contract annulment procedures, and model change procedures with a communication provider, comprising:
a radio terminal used by the user; and
a center device and authentication device with which the radio terminal communicates via a predetermined radio network, wherein
call section for requesting communication with the center device belonging to the communication provider through a predetermined operation performed on the radio terminal using individual information of that radio terminal is provided in the radio terminal,
authenticating section for receiving communication requests from the call section, authenticating a call by checking the individual information used by the call section against individual information of the radio terminal managed by the authentication device, and connecting the call from the radio terminal to the center device via the predetermined radio network is provided in the authentication device, and
communication section for communicating with the radio terminal to which the center device has been connected via the radio network by the authenticating section is provided in the center device, and wherein
the mutual communication of information is carried out between the radio terminal and the center device using the communication section, and
individual information for recording in the radio terminal is sent when required from the center device.
